(19) United States
(12) Patent Application Publication
(10) Pub. No.: US 2014/0334356 A1
(43) Pub. Date: Nov. 13, 2014

(54) RESOURCE MANAGEMENT METHOD AND APPARATUS FOR CONTROLLING INTERFERENCE BETWEEN CELLS

(71) Applicant: Electronics and Telecommunications Research Institute, Daejeon (KR)

(72) Inventors: Eunkyung KIM, Daejeon (KR); Jae Sun CHA, Daejeon (KR); Jae Joon PARK, Daejeon (KR); Hyun LEE, Daejeon (KR); Kwang Jae LIM, Daejeon (KR); Sung Cheol CHANG, Daejeon (KR)

(73) Assignee: Electronics and Telecommunications Research Institute, Daejeon (KR)

(21) Appl. No.: 14/274,718

(22) Filed: May 10, 2014

(30) Foreign Application Priority Data
May 10, 2013 (KR) 10-2013-0053351
Jul. 12, 2013 (KR) 10-2013-0082414
Jan. 17, 2014 (KR) 10-2014-0006300
Apr. 28, 2014 (KR) 10-2014-0051055

(51) Int. Cl. H04W 72/08; H04L 5/00

(52) U.S. Cl. CPC H04W 72/082; H04L 5/006
USPC 370/280; 370/329; 370/281

(57) ABSTRACT

An exemplary embodiment of the present invention provides a resource management method performed by a coordinator for controlling interference between cells. The coordinator receives a channel state of a second base station neighboring a first base station from the first base station. The coordinator partitions a resource based on the channel state. The coordinator allocates the partitioned resource to the first base station. In addition, the coordinator transmits a first message requesting resource management to be set to the first base station. Here, the first message includes information on the allocated resource.

### CROSS-REFERENCE TO RELATED APPLICATION

This application claims priority to and the benefit of Korean Patent Application Nos. 10-2013-0053351, 10-2013-0082414, 10-2014-0006300, and 10-2014-0051055 filed in the Korean Intellectual Property Office on May 10, 2013, Jul. 12, 2013, Jan. 17, 2014, and Apr. 28, 2014, the entire contents of which are incorporated herein by reference.

### BACKGROUND OF THE INVENTION

(a) Field of the Invention

The present invention relates to a resource management method and apparatus for controlling interference between cells.

(b) Description of the Related Art

A terminal positioned at a boundary between cells is subjected to interference from a neighboring cell or interferes with the neighboring cell, such that performance of a network may be deteriorated. Therefore, in order to improve the performance of the network, there is a need to control the interference at a boundary region between the cells.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a resource management method and apparatus for controlling interference between cells having advantages of managing a resource through cooperation between the cells in order to efficiently control the interference between the cells.

An exemplary embodiment of the present invention provides a resource management method performed by a coordinator for controlling interference between cells. The resource management method includes: receiving a channel state of a second base station neighboring a first base station from the first base station; partitioning a resource based on the channel state; allocating the partitioned resource to the first base station; and transmitting a first message requesting resource management to be set to the first base station. Here, the first message includes information on the allocated resource.

The channel state may include information on channel quality of the second base station measured by a terminal. The partitioning of the resource may include partitioning a frequency band into one or more frequency partitions using a frequency division multiplex (FDM) method.

The partitioning of the frequency band into the one or more frequency partitions may include partitioning a second region in which data are transmitted in a first region in which control information is transmitted and the second region within the frequency band into the one or more frequency partitions.

The allocating may include allocating a first frequency partition among the frequency partitions to the first base station. The transmitting of the first message may include allowing bitmap information of a frequency subchannel of the first frequency partition to be included in the first message.

The first message may further include information regarding maximum transmission power strength allowable in each of the frequency partitions.

The partitioning of the resource based on the channel state may include partitioning the resource in a time axis using a time division multiplex (TDM) method to generate one or more partitions.

The partitioning of the resource based on the channel state may further include partitioning a first partition using either one of the TDM method and an FDM method in the case in which the first and second base stations share the first partition among the partitions with each other.

The partitioning of the resource in a time axis using the TDM method may include partitioning a region other than a first region in which control information is transmitted within a resource region in the time axis to generate the one or more partitions, when the first region includes a start point in time of a frame.

The allocating may include allocating a first partition among the partitions to the first base station. The first message may include information on at least one of a start point in time and an end point in time of the first partition.

Another exemplary embodiment of the present invention provides a resource management method performed by a first base station for controlling interference between cells. The resource management method includes: receiving a channel state of a second base station neighboring the first base station from a terminal; transmitting at least either one of the channel state and a use state of the resource to a coordinator; receiving a first message requesting resource management to be set from the coordinator; and using the resource based on information included in the first message.

The channel state may include information on channel quality of the second base station measured by the terminal and information on interference of the second base station in the terminal.

The use state of the resource may include at least one of an average resource use rate per frame and a fluctuation degree of data traffic throughput.

The transmitting of the at least either one of the channel state and the use state of the resource to the coordinator may include transmitting the channel state and the use state of the resource to the coordinator in the case in which a channel state report request is received from the coordinator, in the case in which a period for the channel state report expires, in the case in which a value of either one of the channel state and the use state of the resource is increased or decreased by a first value, or in the case in which the value of either one of the channel state and the use state of the resource is higher than a first threshold value or is lower than a second threshold value.

The using of the resource may include: determining a first resource partition allocated to the first base station in the resource partitioned into one or more resource partitions based on the information included in the first message; and allocating a portion of the first resource partition to the terminal.

The using of the resource may further include transmitting change information of the first resource partition to the terminal through a zone switch information element when the first resource partition is changed.

The allocating of the portion of the first resource partition to the terminal may include: determining a first point in time at which the first resource partition is available based on information on an application point in time in the information included in the first message; and allocating the portion of the first resource partition to the terminal at the first point in time.

The coordinator may be present in the first base station.

Yet another exemplary embodiment of the present invention provides a communication method of a terminal for decreasing interference between cells. The communication method includes: measuring channel quality of a first base station neighboring a serving base station; reporting the measuring result to the serving base station when the measuring result satisfies a first condition; receiving resource information from the serving base station; and performing communication using the resource information.

The first condition may include at least any one of a case in which a channel state report request is received from the serving base station, a case in which a period for a channel state report expires, a case in which a value of the measuring result is increased or decreased by a first value, and a case in which the value of the measuring result is higher than a first threshold value or is lower than a second threshold value. The second threshold value may be smaller than the first threshold value.

The communication method may further include, before the reporting, receiving the first condition from the serving base station.

### BRIEF DESCRIPTION OF THE DRAWINGS

FIG. 1 is a flowchart showing a resource management process for controlling interference according to an exemplary embodiment of the present invention.

FIG. 2 is a diagram showing an example of resource partitioning and allocation using a frequency division multiplex (FDM) scheme according to an exemplary embodiment of the present invention.

FIG. 3 shows diagrams of another example of resource partitioning and allocation using an FDM scheme according to an exemplary embodiment of the present invention.

FIG. 4 is a diagram showing an example of resource partitioning and allocation using a time division multiplex (TDM) scheme according to an exemplary embodiment of the present invention.

FIG. 5 is a diagram showing an interface for setting resource management between a base station and a coordinator according to an exemplary embodiment of the present invention.

FIG. 6 is a diagram showing an example of a parameter included in a C-IM-REQ message of FIG. 5.

FIG. 7 is a diagram showing an example of a parameter included in a C-IM-RSP message of FIG. 5.

FIG. 8 is a diagram showing some parameters of FIG. 7 in detail.

FIG. 9 is a diagram showing an interface for reporting information related to resource management between a base station and a coordinator according to an exemplary embodiment of the present invention.

FIG. 10 is a diagram showing an example of a parameter included in a C-IM-IND message of FIG. 9.

FIG. 11 is a diagram showing some parameters of FIG. 10 in detail.

FIG. 12 is a diagram showing a configuration of a terminal according to an exemplary embodiment of the present invention.

FIG. 13 is a diagram showing a configuration of a base station according to an exemplary embodiment of the present invention.

FIG. 14 is a diagram showing a configuration of a coordinator according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include some or all of functions of the terminal, the MT, the MS, the AMS, the HR-MS, the SS, the PSS, the AT, the UE, or the like.

In addition, a base station (BS) may include an advanced base station (ABS), a high reliability base station (HR-BS), a small base station, a nodeB, an evolved node B (eNodeB), an access point (AP), a radio access station (RAS), a base transceiver station (BTS), a mobile multihop relay (MMR)-BS, a relay station (RS) serving as the base station, a high reliability relay station (HR-RS) serving as the base station, or the like, and may include some or all of functions of the BS, the ABS, the HR-BS, the small base station, the nodeB, the eNodeB, the AP, the RAS, the BTS, the MMR-BS, the RS, the HR-RS, or the like.

Interference control according to an exemplary embodiment of the present invention may be performed using a resource management method for controlling interference and a cooperative transmission (CT) method through interference control. In detail, an interference control method through resource management includes a resource management method using a frequency division multiplex (FDM) scheme, a resource management method using a time division multiplex (TDM) scheme, an interference control method through management of transmission power in a cell, and the like. Meanwhile, the resource management may be performed through cooperation between base stations. Therefore, a resource management method through the cooperation between the base stations is required. Particularly, in various types of cells formed through a small base station or in a multi-layer network in which a macro base station and the small base station are overlapped with each other, an efficiency base station cooperation method and a resource management method for controlling interference are required.

An exemplary embodiment of the present invention relates to a method of managing or controlling cooperation between base stations for controlling interference between cells, a resource management method through the management or the control, and a method of predicting or measuring interference between cells for controlling the interference.

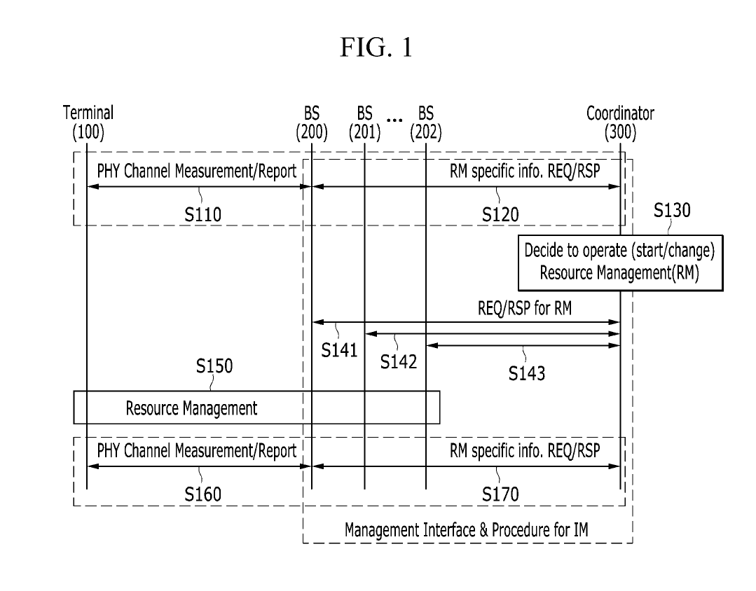

Meanwhile, a system for controlling interference according to an exemplary embodiment of the present invention may include a base station, a terminal, and a coordinator for controlling interference. In detail, the base station and the terminal exchange data with each other through wireless communication. The coordinator may directly manage or control the terminal or may indirectly manage or control the terminal through the base station. Meanwhile, the coordinator may be an independent apparatus separate from the base station. Alternatively, the coordinator may be present in the base station. Hereinafter, for convenience of explanation, the case in which the coordinator is the independent apparatus separate from the base station will be described by way of example in an exemplary embodiment of the present invention. In addition, hereinafter, for convenience of explanation, a downlink frame (or a downlink service) between the base station and the terminal will be described by way of example in an exemplary embodiment of the present invention. However, this is only an example, and an exemplary embodiment of the present invention may be applied to an uplink frame (or an uplink service) in a scheme that is similar to or the same as a scheme in the downlink frame. An exemplary embodiment of the present invention will be described in detail with reference to FIGS. 1 to 14.

FIG. 1 is a flowchart showing a resource management process for controlling interference according to an exemplary embodiment of the present invention. In detail, FIG. 1 shows a management interface and procedure for interference management (IM). A resource management (RM) process for controlling interference may be performed through cooperation between a serving base station 200 and N (N indicates a natural number) neighboring base stations 201 and 202 neighboring the serving base station 200. FIG. 1 shows the case in which the number of neighboring base stations 201 and 202 cooperating with the serving base station 200 is two, for convenience of explanation. A coordinator 300, which is a network control management system (NCMS), may be a controller controlling interference management.

A terminal 100 measures a state (for example, a channel quality such as a signal to interference plus noise ratio (SINR), a carrier to interference noise ratio (CINR), or the like) of a channel (for example, a physical (PHY) channel) for wireless communication and reports a measurement result to the serving base station 200 (S110). Here, the channel state may include interference information (for example, information on interference of the neighboring base stations 201 and 202 in the terminal 100) by the neighboring base stations 201 and 202.

The serving base station 200 receiving the report for the channel state and reports the channel state to the coordinator 300 (S120). In detail, the serving base station 200 may report the channel state to the coordinator in the case in which a value of the channel state is a threshold value or less, report the channel state to the coordinator periodically, report the channel state to the coordinator whenever it receives a report for the channel state from the terminal, or report the channel state to the coordinator in the case in which it receives a report request from the coordinator 300.

The coordinator 300 receiving the report for a channel state result from at least one base station 200 decides whether or not interference control should be performed depending on the channel state of each base station 200 to 202 (S130). In detail, the coordinator 300 may receive reports for channel states from other base stations (for example, 201 and 202) as well as from the serving base station 200. The coordinator 300 may decide whether resource management (RM) starts or is changed.

In the case in which it is decided that the interference control is required, the coordinator 300 requests the base station 200 and the neighboring base stations 201 and 202 reporting the channel state result to control the interference depending on an interference control method (S141 to S143). In detail, the coordinator 300 may request some or all of the base stations 200 to 202 included in the reported channel state result to control the interference. The base stations 200 to 202 receiving the interference control request transmit a response message to the coordinator 300 (S141 to S142). Meanwhile, the coordinator 300 may also control a base station that does not receive the interference control request other than the base stations 200 to 202, thereby performing the interference control. Meanwhile, the coordinator 300 may change resources used for controlling the interference and may not perform the interference control in the case in which it is decided that the interference control is no longer required. In addition, the coordinator 300 may also start resource management for controlling the interference with respect to resources used without considering the interference control.

Meanwhile, before the base station 200 serves the terminal 100, the coordinator 300 may manage resources between the base stations 200 to 202 in order to avoid interference between cells.

The base stations 200 to 202 perform the resource management for the terminal 100 in response to the interference control request of the coordinator 300 (S150). The base station 200 serves the terminal 100 through resources set by the resource management. In detail, the base stations 200 to 202 receiving the interference control request from the coordinator 300 may set the resource management and serve the terminal through the set resources.

The terminal 100 may measure a channel state of the served resource and report the channel state to the serving base station 200 (S160).

The serving base station 200 may report the reported channel state to the coordinator 300 (S170). Then, the coordinator 300 may reset the resources through the above-mentioned processes S130 and S141 to S143 or end the interference control.

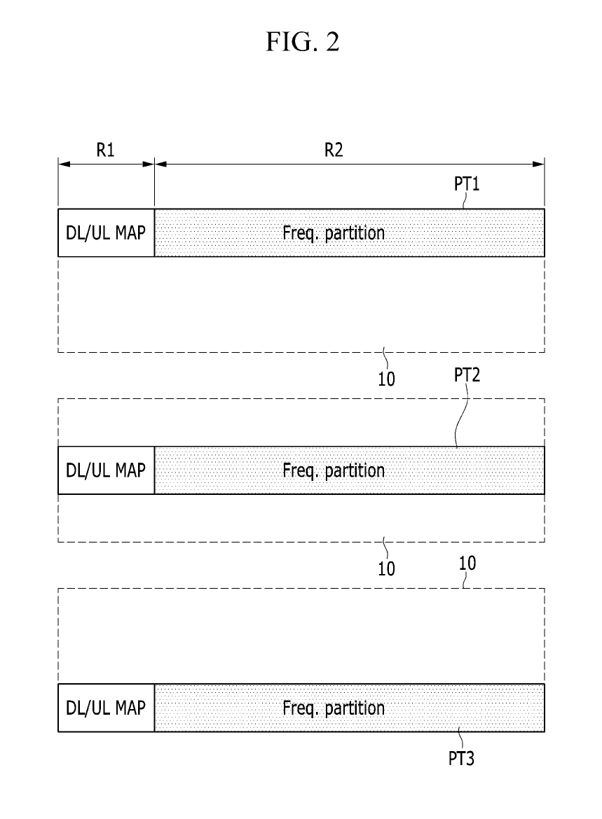

Now, resource management (for example, resource partitioning or resource allocation) by the coordinator 300 will be described in detail with reference to FIGS. 2 to 4.

FIG. 2 is a diagram showing an example of resource partitioning and allocation using a frequency division multiplex (FDM) scheme according to an exemplary embodiment of the present invention. In detail, FIG. 2 shows the case in which the base stations 200 to 202 use a system frequency band 10 through frequency subchannel allocation.

The coordinator 300 may partition the frequency band 10 into one or more frequency partitions PT1, PT2, and PT3. For convenience of explanation, FIG. 2 shows the case in which the frequency band 10 is partitioned into three frequency partitions PT1 to PT3. In addition, the coordinator 300 may inform the respective base stations 200 to 202 of channels that may be used by the respective base stations 200 to 202 among subchannels configured of the frequency partitions PT1 to PT3. Here, sizes of the respective frequency partitions PT1 to PT3 may be the same as or different from each other. Predefined resources (defined as the number or positions of subchannels) may be used as the frequency partitions PT1 to PT3 or the coordinator 300 may command the frequency partitions PT1 to PT3, thereby informing the base stations 200 to 202 of resource information on the frequency partitions PT1 to PT3. Meanwhile, one base station (for example, 200) may occupy one frequency partition (for example, PT1). Alternatively, several base stations (for example, 200 and 201) may share one frequency partition (for example, PT1) with each other. In the case in which several base stations 200 and 201 share one frequency partition PT1 with each other, the coordinator 300 may further partition and allocate resources in the frequency partition PT1 using an FDM or TDM scheme in order to control interference between the base stations 200 and 201 sharing the frequency partition PT1 with each other.

Meanwhile, in the case in which the frequency partition (for example, PT2) is defined by a pre-defined subchannel, the coordinator 300 may inform the base stations 200 to 202 of information on the frequency partition PT2.

Meanwhile, the coordinator 300 determines a sequence of the subchannels in order to inform the base stations 200 to 202 of available frequency partitions PT1 to PT3. In addition, the coordinator 300 may inform the base stations 200 to 202 of the available frequency partitions PT1 to PT3 using a bitmap form for the subchannels of which the sequence is determined, numbers of the subchannels, sizes of available subchannels, or the like. Here, a scheme of using the bitmap form is a scheme of displaying subchannels that may be used by the base stations 200 to 202 and subchannels that may not be used by the base stations 200 to 202 using bitmaps corresponding to the subchannels.

Here, in the case in which the bitmap is used, a size of the bitmap may be configured of the number of subchannels of an entire system. Meanwhile, in the case in which one frequency partition (for example, PT1) shared by several base stations (for example, 200 and 201) is additionally partitioned by the FDM scheme, bitmap forms, numbers of subchannels, sizes of available subchannels, or the like, may be used to inform the base stations 200 and 201 of subchannels of the available frequency partition PT1. In this case, a sequence of the subchannels may be reset to a sequence within the frequency partition PT1. In addition, the size of the bitmap may be configured of the number of subchannels of the entire system, or may be limited to the number of subchannels allocated to the frequency partition PT1 in the case in which the sequence of the subchannels may be reset to the sequence within the frequency partition PT1.

Meanwhile, the coordinator 300 may partition a region R1 in which control information (for example, a downlink or uplink map (DL/UL MAP) message) within a frame is transmitted and a region R2 in which data are transmitted to generate frequency partitions PT1 to PT3. Alternatively, the coordinator 300 may also partition only a region (region in which data are transmitted) R2 other than the region R1 in which the control information (DL/UL MAP message) within the frame is transmitted to generate the frequency partitions PT1 to PT3. For convenience of explanation, FIG. 2 shows the case in which the coordinator 300 partitions only the region R2 in which the data are transmitted to generate the frequency partitions PT1 to PT3.

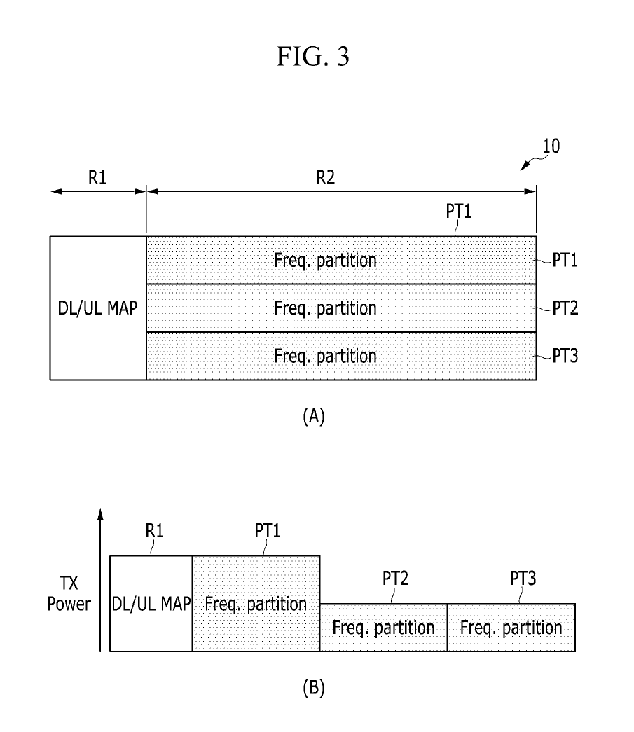

FIG. 3 A and B are diagrams showing another example of resource partitioning and allocation using an FDM scheme according to an exemplary embodiment of the present invention. In detail, FIG. 3 A and B show a fractional frequency reuse (FFR). In FIG. 3 A and B, the case of controlling interference between the base stations 200 to 202 by controlling transmission power of the base stations 200 to 202 for all frequency subchannels 10 is shown. For convenience of explanation, in FIG. 3, A shows the case in which the coordinator 300 partitions a region R2 in which data are transmitted in a region R1 in which control information (for example, DL/UL MAP message) is transmitted and the region R2 to generate frequency partitions PT1 to PT3. FIG. 3 B shows maximum transmission power strengths allocated to the respective frequency partitions PT1 to PT3.

As shown in FIG. 3 A, in the case in which the coordinator 300 allows the base stations 200 to 202 to use all frequencies 10, the coordinator 300 may inform the base stations 200 to 202 of the corresponding fact. In detail, the coordinator 300 may set all of the bitmaps described in FIG. 2 so as to be used. In addition, as shown in FIG. 3 B, the coordinator 300 may additionally inform the base stations 200 to 202 of allowable maximum transmission power strengths of the respective frequency partitions PT1 to PT3. In FIG. 3 B, the case in which an allowable maximum transmission power strength having the same magnitude is allocated to the region R1 in which the control information is transmitted and the frequency partitions PT1 and allowable maximum transmission power strengths having a magnitude lower than that of the allowable maximum transmission power strength allocated to the frequency partition PT1 are allocated to the frequency partitions PT2 and PT3 is shown. In detail, in the case in which the respective frequency partitions PT1 to PT3 are defined as predefined positions or sizes of subchannels, the coordinator 300 may inform the base stations 200 to 202 of information on the respective frequency partitions PT1 to PT3 and allowable maximum transmission power strengths of the respective frequency partitions PT1 to PT3. For example, the coordinator 300 may inform the base stations 200 to 202 of the frequency partitions PT1 to PT3 configured of the subchannels to 202 using the bitmaps, the numbers of the subchannels, the number of available subchannels, or the like, described above with reference to FIG. 2, and may additionally inform the base stations 200 to 202 of the transmission power strengths of the respective frequency partitions PT1 to PT3. Meanwhile, the control information in the region R1 in which the control information is transmitted may be transmitted as the allowable maximum transmission power strength or as the maximum transmission power strengths allocated to the respective partitions PT1 to PT3.

Meanwhile, when the resource management (for example, the resource allocation or the resource allocation) between the coordinator 300 and the base stations 200 to 202 described above with reference to FIGS. 2 to 3B is completed, the base station 200 may inform the terminal 100 of whether or not the resource is used and information on the used resource. Then, the terminal 100 may measure a state of a radio channel based on the information received from the base station 200 and report a measurement result to the base station 200. Meanwhile, in order to efficiently apply the FDM scheme to the resource management, the same subchannelization (for example, the use of the same permutation) may also be applied between the base stations 200 to 202 managing or using the resources through the interference control. Through this, the interference between the base stations 200 to 202 may be further minimized.

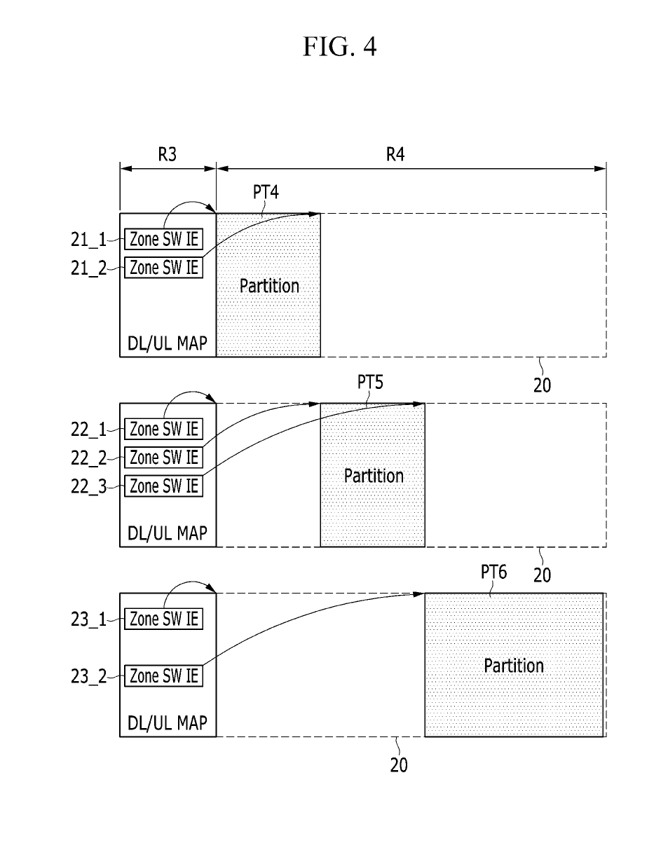

FIG. 4 is a diagram showing an example of resource partitioning and allocation using a time division multiplex (TDM) scheme according to an exemplary embodiment of the present invention.

In order to partition a resource in the TDM scheme, the coordinator 300 may partition a radio frame 20 in a time axis (symbol unit in the case of an orthogonal frequency division multiple access (OFDMA) scheme) to generate one or more partitions PT4 to PT6 and allocate the generated partitions PT4 to PT6 to the base stations 200 to 202. The respective base stations 200 to 202 may occupy the respective partitions PT4 to PT6 and serve the terminal 100 using the partitions PT4 to PT6 occupied by them. Alternatively, several base stations (for example, 200 and 201) may share one partition (for example, PT4) with each other, and the respective base stations 200 and 201 may serve the terminal 100 using the shared partition PT4. In the case in which several base stations 200 and 201 share one partition PT4 with each other, the coordinator 300 may further partition and allocate a resource in the partition PT4 using the FMD or TDM scheme. The coordinator 300 may control the base stations 200 and 201 using information on the allocated resource.

The coordinator 300 may inform the base stations 200 to 202 of information on the partitions PT4 to PT6 partitioned in the time axis. In the case in which the partitions PT4 to PT6 are defined as predefined regions, the coordinator 300 may inform the base stations 200 to 202 of the information on the partitions PT4 to PT6. In detail, the coordinator 300 may inform the base stations 200 to 202 of start points in time and end points in time of the partitions PT4 to PT6.

Meanwhile, as shown in FIG. 4, in the case in which a region R3 in which control information (for example, DL/UL MAP message) is transmitted includes a start point in time of the frame 20 (that is, in the case in which all of the base stations 200 to 202 transmit the control information (for example, a DL/UL MAP message) at the start point in time of the frame 20, the region R3 may be excluded from targets of resource partitioning and allocation using the TDM scheme, and all of the base stations 200 to 202 may use the region R3 in order to transmit the control information. In FIG. 4, the case in which the coordinator 300 partitions only a region R4 in which data are transmitted in the time axis to generate the partitions PT4 to PT6 is shown. Meanwhile, the region R3 may be included in the targets of the resource partitioning and allocation using the TDM scheme, and the respective base stations 200 to 202 may transmit the control information in regions allocated thereto within the region R3.

Meanwhile, in the case in which the coordinator 300 transmits information on the partition PT4 to the base station (for example, 200) in a state in which a start point in time of the partition PT4 is omitted, the base station 200 may consider that the start point in time of the partition PT4 is a start point in time of the frame 20 or a point in time after a transmission point in time of the control information. Meanwhile, in the case in which the coordinator 300 transmits information on the partition PT5 to the base station (for example, 201) in a state in which an end point in time of the partition PT5 is omitted, the base station 200 may consider that the end point in time of the partition PT5 is a final point in time of the frame 20 or a start point in time of the next partition PT6. Meanwhile, the coordinator 300 may inform the base stations 200 to 202 in a symbol of a time axis of all frames 20 in a bitmap form.

Meanwhile, the base station 200 may inform the terminal 100 of change information (for example, information on a partition (for example, PT4) that is used, information on partitions (for example, PT5 and PT6) that are not used, and the like) on the partitions PT4 to PT6 through the control information (for example, zone switch information elements 21_1, 21_2, 22_1 to 22_3, 23_1, and 23_2). For example, the zone switch information element 21_1 and the zone switch information element 21_2 may indicate a start point in time (or an end point in time of the region R3) and an end point in time of the partition PT4, respectively. In addition, the zone switch information element 22_1, the zone switch information element 22_2, and the zone switch information element 22_3 may indicate the end point in time of the region R3, and a start point in time and an end point in time of the partition PT5, respectively. Further, the zone switch information element 23_1 and the zone switch information element 23_2 may indicate the end point in time of the region R3 and a start point in time of the partition PT6, respectively. Through this, the terminal 100 may recognize that the partitions (for example, PT5 and PT6) that are not partitions (for example, PT4) capable of being used by the terminal 100 are a region in which communication with the base station 200 is not made. Alternatively, in the case in which the base station 200 allocates the resources to the terminal 100, the base station 200 may allocate the resources (some of the resources allocated to the base station 200) to the terminal 100 to avoid a region of which the use is limited by the coordinator 300. Alternatively, the base station 200 may use the resources but serve the terminal 100 at a limited transmission power strength in order to decrease interference with the neighboring base stations 201 and 202. In this case, the coordinator 300 may allow allowable transmission power strength to be included in the information on the partitions PT4 to PT6 at the time of partitioning and allocating the resources.

Meanwhile, the terminal 100 reports channel states of the base stations 200 to 202 to the serving base station 200. The serving base station 200 receiving the report for the channel state reports a result of the channel state to the coordinator 300. The coordinator 300 may manage the resources based on the reported channel state. The report and request processes (for example, S110 and S120 of FIG. 1) for controlling the interference as described above may be concretely performed as follows.

The terminal 100 may report the channel state to the serving base station 200 in the case in which a first report condition is satisfied. The first report condition may include at least any one of a first case in which a channel state report request is received from the base station 200, a second case in which a timer corresponding to a transmission period expires in the case in which the terminal 100 is set so as to periodically transmit the channel state, a third case in which a value of the channel state to be reported is increased or decreased from a previously measured value by a predetermined value or more or a predetermined value or less, and a fourth case in which a value of the channel state is an upper limit threshold value or more or a lower limit threshold value or less. The first report condition may be transmitted from the serving base station 200 to the terminal 100, or may be applied by a predefined method. For example, in the case in which the serving base station 200 provides the first report condition including the first and second cases among the first to fourth cases to the terminal 100, the terminal 100 may report the channel state to the serving base station 200 when the first or second case is satisfied.

The serving base station 200 receiving the report for the channel state from the terminal 100 may report the result of the channel state to the coordinator 300 in the case in which a second report condition is satisfied. The second report condition may include at least any one of a case in which a channel state report is received from the terminal 100, a case in which a channel state report request is received from the coordinator 300, a case in which a timer corresponding to a transmission period expires in the case in which the base station 200 is set so as to periodically transmit the channel state, a case in which a value of the channel state to be reported is increased or decreased from a previously measured value by a predetermined value or more or a predetermined value or less, and a case in which a value of the channel state is an upper limit threshold value or more or a lower limit threshold value or less.

Meanwhile, the resource management for controlling the interference may be set or reset based on a use state of the resources of the base stations 200 to 202. To this end, the base station (for example, 200) may report how many resources allocated from the coordinator 300 the base station 200 uses to the coordinator 300. The use state of the resources may include available radio resource information and radio resource fluctuation information. Here, the available radio resource information indicates a use rate of a downlink (or uplink) resource used per one frame or an average resource use rate. The average resource use rate may be calculated so as to include a previously reported use rate or be calculated in consideration of only a use rate after a previous report. The radio resource fluctuation information may indicate a numerical value representing fluctuation of a data traffic throughput through the use of the resources. For example, a radio resource fluctuation degree may be represented by any one value in a range of 0 to 255 (here, 0 indicates that the data traffic throughput is substantially constant and 255 indicates that the data traffic throughput is significantly changed). The base station 200 may report a use state of the resources to the coordinator 300 in the case in which at least any one of the cases of the second report condition is satisfied, similar to the process of reporting the channel state to the coordinator 300. In this case, the use state of the resources instead of the channel state is applied in the second report condition. The coordinator 300 may set (or reset) resource management based on the reported use state of the resources and determine allocation resources.

Meanwhile, a method of applying interference control is as follows. The base stations 200 to 202 receive information on resources that are to be used for controlling interference and resources that are not to be used for controlling the interference and a set request for the use of the resources from the coordinator 300. The base stations 200 to 202 may use the resources based on the information received from the coordinator 300, thereby applying the interference control. In detail, a point in time at which the interference control is applied may be a point in time immediately after interference control related information is received, a specific time, or a point in time after a predetermined time elapses from a point in time at which the interference control related information is received, or the like. The coordinator 300 allows information on the point in time at which the interference control is applied to be included in information on the use of the resources and transmits the information to the base stations 200 to 202, thereby making it possible to control the setting of the base stations 200 to 202.

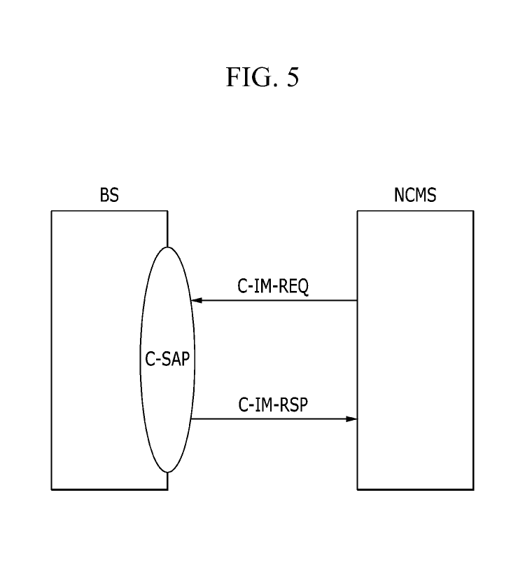

Now, an interface between the base stations 200 to 202 and the coordinator 300 related to an operation for the interference control described above will be described in detail with reference to FIGS. 5 to 11. An NCMS in FIGS. 5 to 11 may be the coordinator 300.

FIG. 5 is a diagram showing an interface for setting resource management between a base station 200 and a coordinator 300 according to an exemplary embodiment of the present invention.

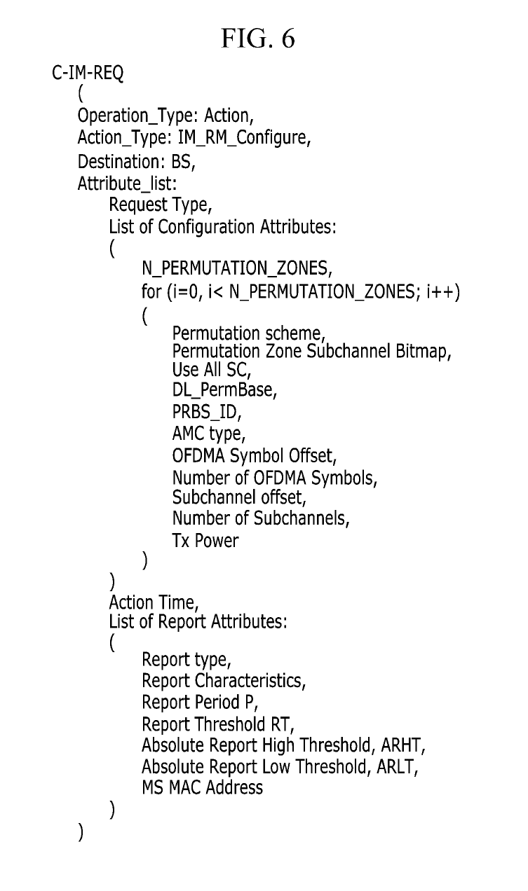

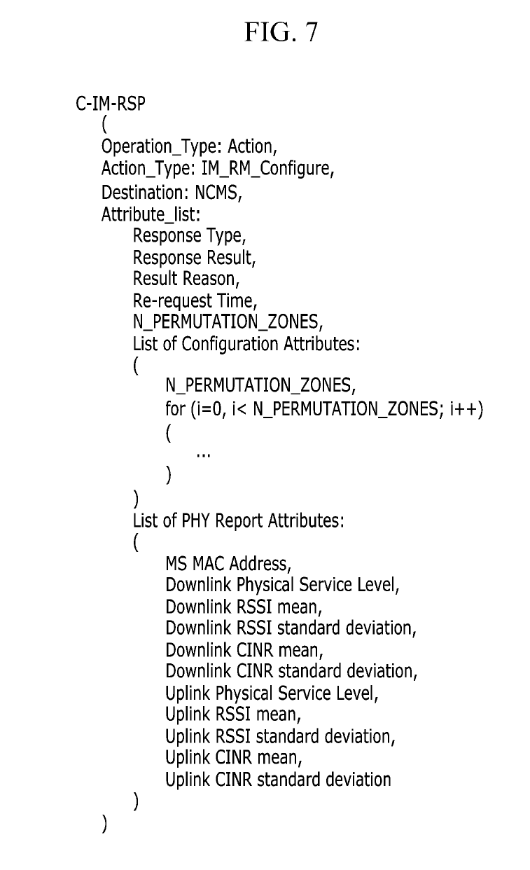

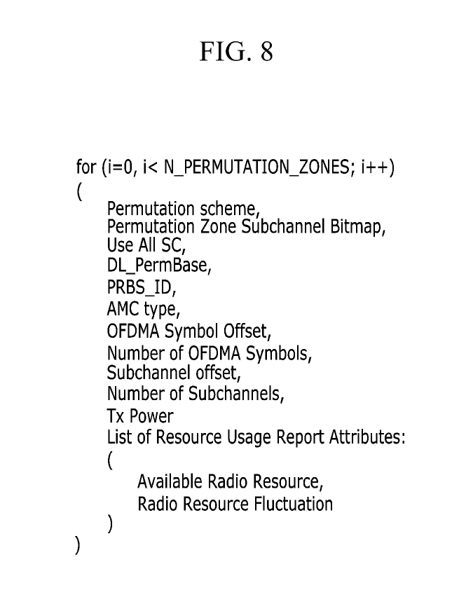

The coordinator 300 transmits a request message (for example, a C-IM-REQ message) for the resource management to the base station 200 through a control plane service access point (C-SAP), and the base station 200 transmits a response message (for example, a C-IM-RSP message) for the resource management to the coordinator 300 through the C-SAP. The C-IM-REQ message will be described in detail with reference to FIG. 6, and the C-IM-RSP message will be described in detail with reference to FIGS. 7 and 8.

FIG. 6 is a diagram showing an example of a parameter included in a C-IM-REQ message of FIG. 5.

The C-IM-REQ message is a message through which the coordinator 300 requests the base station 200 to set the resource management for controlling the interference. Parameters that may be included in the C-IM-REQ message are shown in FIG. 6. In detail, as shown in the following Table 1, a Request Type parameter indicates a request type, a Bit 0 of the Request Type Parameter indicates a type requesting setting of partitions, and a Bit 1 of the Request Type Parameter indicates a type requesting a state report.

TABLE 1

| Parameter | Remarks |
|---|---|
| Request Type | Type of request; bitmap: |
| | a) Bit 0: Set the partition |
| | b) Bit 1: Report status |

Meanwhile, in the case in which the Request Type parameter is set to ‘Set the partition’, parameters shown in the following Table 2 become valid.

TABLE 2

| Parameter | Remarks |
|---|---|
| N_PERMU- | Number of radio frame subsections for which |
| TATION_ZONES | the resource partition will be indicated. |
| | A value of 1 indicates that the entire DL and |
| | UL radio subframe is considered to be a single |
| | permutation zone each. |
| Permutation | Denotes permutation scheme used in the |
| scheme | current permutation zone. |
| | The following types are possible: |
| | a) DL PUSC permutation |
| | b) DL FUSC permutation |
| | c) DL Optional FUSC permutation |
| | d) DL AMC |
| | e) DL TUSC1 |
| | f) DL TUSC2 |
| | g) UL PUSC |
| | h) UL AMC |
| Permutation Zone | Indicates the subchannels available for |
| Subchannel Bitmap | transmission in the current permutation zone |
| Use All SC | When set, this field indicates transmission on |
| | all available subchannels. |
| | For FUSC permutation, transmission is |
| | always on all subchannels. |
| DL_PermBase | DL Permutation base for the specified DL |
| | zone |
| | DL_PermBase field shall be set to the 5 LSBs |
| | (Least Significant Bits) of IDcell as indicated by |
| | the frame preamble. |
| PRBS_ID | Values: 0 . . . 2 |
| AMC type | Indicates the AMC type in case permutation |
| | type = 0b11, otherwise shall be set to 0. |
| | AMC type (NxM = N bits by M symbols): |
| | a) 1x6 |
| | b) 2x3 |
| | c) 3x2 |
| | Note that only 2x3 band AMC subchannel |
| | type (AMC Type = 0b01) is supported by MS. |
| OFDMA Symbol | Denotes the start of the current permutation |
| Offset | zone in number of OFDMA symbols (counting |
| | from the frame preamble and starting at 0). |
| Number of OFDMA | Denotes the number of OFDMA symbols |
| Symbols | used in the current permutation zone. |
| Subchannel | Denotes the start of the current zone in |
| offset | number of OFDMA subchannels. |
| Number of | Denotes the number of OFDMA subchannels |
| Subchannels | used in the current permutation zone. |
| Tx Power | Denotes the maximum transmit power used in |
| | the current permutation zone (in dBm). |
| Action Time | Denotes the time to start this action. |

Meanwhile, in the case in which the Request Type parameter is set to ‘Report status’, parameters shown in the following Table 3 become valid.

TABLE 3

| Parameter | Remarks |
|---|---|
| Report type | Indicates the type to report the status: |
| | a) radio resource status |
| | b) report the link level quality for a specific MS |
| Report | Indicates whether the report shall be sent periodically, |
| Characteristics | or event driven. |
| | a) Bit 0: Periodically as defined by report period P. |
| | b) Bit 1: regularly whenever resources have changed |
| | as defined by RT since the last report. |
| | c) Bit 2: Change of IM RM configuration (set the |
| | partition). This report shall be given whenever any of |
| | the parameters (Request type [bit 0] is set to “set the |
| | partition”) at the BS have changed. |
| | d) Bit 3: Report shall be given per permutation zone. |
| Report Period P | The Time P is used by the BS as reporting period for |
| | producing the information requested by the NCMS. |
| Report | The threshold value RT shall be used by the BS to |
| Threshold, RT | send another report as soon as value to report |
| | increases by more than that threshold value or |
| | decreases by less than that threshold value. |
| Absolute Report | The threshold value ART shall be used by the BS to |
| High Threshold, | send another report as soon as value to report is greater |
| ARHT | than ARHT. |
| Absolute Report | The threshold value ART shall be used by the BS to |
| Low Threshold, | send another report as soon as value to report is less |
| ARLT | than ARLT. |
| MS MAC | 48-bit unique identifier of the MS. |
| Address | Only valid when the report type is for ‘report the link |
| | level quality for a specific MS’ |

FIG. 7 is a diagram showing an example of a parameter included in a C-IM-RSP message of FIG. 5. In addition, FIG. 8 is a diagram showing some parameters (loop for (i=0, i<N_PERMUTATION_ZONES; i++)) of FIG. 7 in detail.

The C-IM-RSP message is a response message to the resource management setting request of the coordinator 300. Parameters that may be included in the C-IM-RSP message are shown in FIG. 7. In detail, a Response Type parameter, a Response Result parameter, a Result Reason parameter, and a Re-request Time parameter in FIG. 7 may be defined as shown in the following Table 4.

TABLE 4

| Parameter | Remarks |
|---|---|
| Response | Type of report profiles: |
| Type | a) Partitioning configuration complete |
| | b) Resource Usage Report |
| | c) PHY Report |
| Response | Indicates the result of the operation indicated by the Response |
| Result | Type parameter included in the received C-IM-REQ |
| | primitives. |
| | This parameter may include ‘success’, ‘failure’, or ‘re-request’ |
| Result | Indicates a reason for ‘failure’ or ‘re-request’ |
| Reason | This parameter is included in this primitive only when the |
| | ‘Response Result’ in this primitive is set to ‘failure’ or |
| | ‘re-request’ |
| Re- | Indicates a time to re-request the C-IM-REQ. |
| request | This parameter may be included in this primitive only when |
| Time | the ‘Response Result’ in this primitive is set to ‘re-request’ |

Meanwhile, in the case in which the Response Type parameter is set to ‘Partitioning configuration complete’ or ‘Resource Usage Report’ and the Response Result parameter is set to ‘success’, parameters shown in the following Table 5 become valid.

TABLE 5

| parameter | Remarks |
|---|---|
| N_PERMU- | Number of radio frame subsections for which the |
| TATION_ZONES | resource partition will be indicated. |
| | A value of 1 indicates that the entire DL and UL |
| | radio subframe is considered to be a single |
| | permutation zone each. |
| Permutation | Denotes permutation scheme used in the |
| scheme | current permutation zone. |
| | The following types are possible: |
| | a) DL PUSC (Partial Usage Subcarrier) |
| | permutation |
| | b) DL FUSC (Full Usage Subcarrier) permutation |
| | c) DL Optional FUSC permutation |
| | d) DL AMC(Adaptive Modulation and Coding) |
| | e) DL TUSC(Tile Usage Sub Carrier)1 |
| | f) DL TUSC2 |
| | g) UL PUSC |
| | h) UL AMC |
| OFDMA Symbol | Denotes the start of the current permutation |
| Offset | zone in number of OFDMA symbols (counting |
| | from the frame preamble and starting at 0) |

Meanwhile, in the case in which the Response Type parameter is set to ‘Partitioning configuration complete’, parameters shown in the following Table 6 become valid.

TABLE 6

| Parameter | Remarks |
|---|---|
| Permutation | Indicates the subchannels available for |
| Zone Sub- | transmission in the current permutation zone |
| channel Bitmap | |
| Use All SC | When set, this field indicates transmission on all |
| | available subchannels. |
| | For FUSC permutation, transmission is always on |
| | all subchannels. |
| DL_PermBase | DL Permutation base for the specified DL zone. |
| | DL_PermBase field shall be set to the 5 LSBs of |
| | IDcell as indicated by the frame preamble. |
| PRBS_ID | Values: 0 . . . 2 |
| AMC type | Indicates the AMC type in case permutation type = |
| | 0b11, otherwise shall be set to 0. |
| | AMC type (NxM = N bits by M symbols): |
| | a) 1x6 |
| | b) 2x3 |
| | c) 3x2 |
| | Note that only 2x3 band AMC subchannel type |
| | (AMC Type = 0b01) is supported by MS. |
| Number of | Denotes the number of OFDMA symbols used in |
| OFDMA Symbols | the current permutation zone. |
| Subchannel | Denotes the start of the current zone in number of |
| offset | OFDMA subchannels. |
| Number of | Denotes the number of OFDMA subchannels used |
| Subchannels | in the current permutation zone. |
| Tx Power | Denotes the maximum transmit power used in the |
| | current permutation zone (in dBm). |

Meanwhile, in the case in which the Response Type parameter is set to ‘Resource Usage report’, parameters shown in the following Table 7 become valid.

TABLE 7

| Parameter | Remarks |
|---|---|
| Available | Percentage of reported average available subchannels and |
| Radio | symbol resources (‘slots’) per frame. |
| Resource | If N_PERMUTATION_ZONES > 1, the indicator covers a |
| | permutation zone instead of the entire DL or UL radio |
| | subframe. |
| Radio | Radio Resource Fluctuation is used to indicate the degree of |
| Resource | fluctuation in DL and UL channel data traffic throughputs. |
| Fluctu- | If N_PERMUTATION_ZONES > 1, the indicator covers a |
| ation | permutation zone instead of the radio frame. |
| | When Radio Resource Fluctuation is set to 0, it implies that |
| | the DL and UL data traffic is constant in data throughput. |
| | Hence, there is no fluctuation in Available Radio Resource. |
| | When Radio Resource Fluctuation is set to maximum value |
| | 255, the data traffic is very volatile in nature, which makes |
| | the Available Radio Resource unpredictable. |
| | The Radio Resource Fluctuation for all traffic models should |
| | be in the range of 0 to 255. |

Meanwhile, in the case in which the Response Type parameter is set to ‘PHY report’ and the Response Result parameter is set to ‘success’, parameters shown in the following Table 8 become valid.

TABLE 8

| Parameter | Remarks |
|---|---|
| MS MAC | 48-bit unique identifier of the MS. |
| Address | |
| Downlink | Channel rate available for the MS calculated as a |
| Physical Service | multiple of 1/32 of nominal bandwidth in the |
| Level | correspondent direction assuming 1 bit/Hz. |
| | For example, if DL channel bandwidth is 10 MHz, |
| | value PSL = 4 means 4 × 1/32 × 10 Mbps = 1.25 |
| | Mbps. |
| | 1 PSL 96 (Number of subchannels in different |
| | OFDMA modes is multiple of 16 or 32; highest |
| | modulation QAM64 provides 3 bits/Hz) |
| Downlink RSSI | |
| mean | |
| Downlink RSSI | |
| standard | |
| deviation | |
| Downlink CINR | |
| mean | |
| Downlink CINR | |
| standard | |
| deviation | |
| Uplink Physical | Channel rate available for the MS calculated as a |
| Service Level | multiple of 1/32 of nominal bandwidth in the |
| | correspondent direction assuming 1 bit/Hz. (see |
| | definition of Downlink Physical Service Level) |
| Uplink RSSI | |
| mean | |
| Uplink RSSI | |
| standard | |
| deviation | |
| Uplink CINR | |
| mean | |
| Uplink CINR | |
| standard | |
| deviation | |

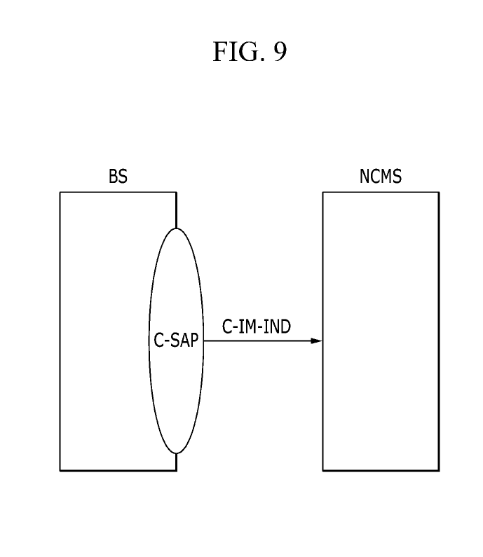

FIG. 9 is a diagram showing an interface for reporting information related to resource management between a base station 200 and a coordinator 300 according to an exemplary embodiment of the present invention.

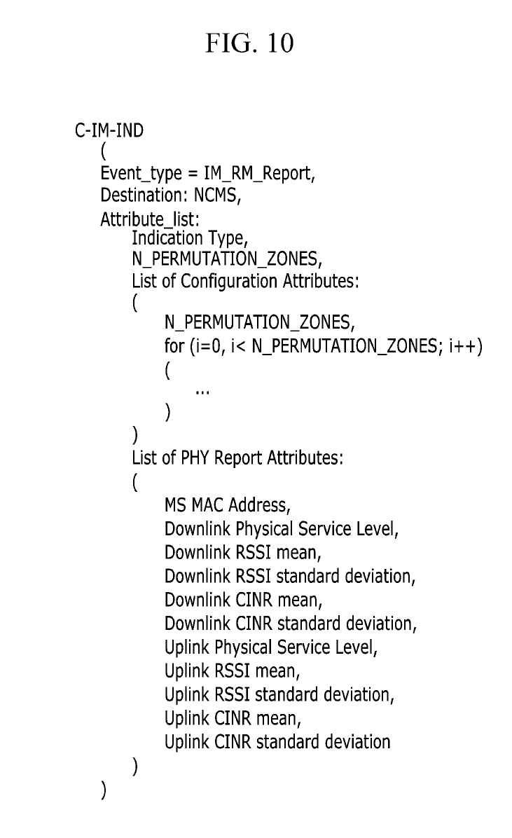

In detail, the base station 200 transmits a message (for example, a C-IM-IND message) for the resource management to the coordinator 300 through the C-SAP. The C-IM-IND message will be described in detail with reference to FIG. 10.

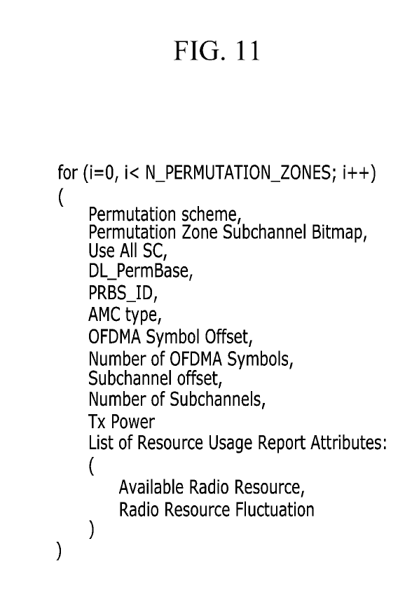

FIG. 10 is a diagram showing an example of a parameter included in a C-IM-IND message of FIG. 9. In addition, FIG. 11 is a diagram showing some parameters (loop for (i=0, i<N_PERMUTATION_ZONES; i++)) of FIG. 10 in detail. The C-IM-IND message shown in FIG. 10 is a message transmitted in the case in which the base station 200 reports information related to setting of the resource management to the coordinator 300. As described above, a resource management related report may be performed when an event occurs or periodically by the base station 200 in the case on which the second report condition is satisfied.

Parameters that may be included in the C-IM-IND message are shown in FIGS. 10 and 11. In detail, as shown in the following Table 9, an Indication Type parameter in FIG. 10 indicates a type of a report profile.

TABLE 9

| Parameter | Remarks |
|---|---|
| Indication Type | Type of report profiles: |
| | a) Partitioning configuration complete |
| | b) Resource Usage Report |
| | c) PHY Report |

Meanwhile, in the case in which the Indication Type parameter is set to ‘Partitioning configuration complete’ or ‘Resource Usage Report’, parameters shown in the following Table 10 become valid.

TABLE 10

| Parameter | Remarks |
|---|---|
| N_PERMU- | Number of radio frame subsections for which the |
| TATION_ZONES | resource partition will be indicated. |
| | A value of 1 indicates that the entire DL and UL |
| | radio subframe is considered to be a single |
| | permutation zone each. |
| Permutation | Denotes permutation scheme used in the |
| scheme | current permutation zone. |
| | The following types are possible: |
| | a) DL PUSC permutation |
| | b) DL FUSC permutation |
| | c) DL Optional FUSC permutation |
| | d) DL AMC |
| | e) DL TUSC1 |
| | f) DL TUSC2 |
| | g) UL PUSC |
| | h) UL AMC |
| OFDMA Symbol | Denotes the start of the current permutation |
| Offset | zone in number of OFDMA symbols (counting |
| | from the frame preamble and starting from 0) |

Meanwhile, in the case in which the Indication Type parameter is set to ‘Partitioning configuration complete’, parameters shown in the following Table 11 become valid.

TABLE 11

| Parameter | Remarks |
|---|---|
| Permutation | Indicates the subchannels available for |
| Zone Sub- | transmission in the current permutation zone. |
| channel Bitmap | |
| Use All SC | When set, this field indicates transmission on all |
| | available subchannels. |
| | For FUSC permutation, transmission is always on |
| | all subchannels. |
| DL_PermBase | DL Permutation base for the specified DL zone. |
| | DL_PermBase field shall be set to the 5 LSBs of |
| | IDcell as indicated by the frame preamble. |
| PRBS_ID | Values: 0 . . . 2 |
| AMC type | Indicates the AMC type in case permutation type = |
| | 0b11, otherwise shall be set to 0. |
| | AMC type (NxM = N bits by M symbols): |
| | a) 1x6 |
| | b) 2x3 |
| | c) 3x2 |
| | Note that only 2x3 band AMC subchannel type |
| | (AMC Type = 0b01) is supported by MS. |
| Number of | Denotes the number of OFDMA symbols used in |
| OFDMA Symbols | the current permutation zone. |
| Subchannel | Denotes the start of the current zone in number of |
| offset | OFDMA subchannels. |
| Number of | Denotes the number of OFDMA subchannels used |
| Subchannels | in the current permutation zone. |
| Tx Power | Denotes the maximum transmit power used in the |
| | current permutation zone (in dBm). |

Meanwhile, in the case in which the Indication Type parameter is set to ‘Resource Usage Report’, parameters shown in the following Table 12 become valid.

TABLE 12

| Parameter | Remarks |
|---|---|
| Available | Percentage of reported average available subchannels and |
| Radio | symbols resources (‘slots’) per frame. |
| Resource | If N_PERMUTATION_ZONES > 1, the indicator covers a |
| | permutation zone instead of the entire DL or UL radio |
| | subframe. |
| Radio | Radio Resource Fluctuation is used to indicate the degree of |
| Resource | fluctuation in DL and UL channel data traffic throughputs. |
| Fluctu- | If N_PERMUTATION_ZONES > 1, the indicator covers a |
| ation | permutation zone instead of the radio frame. |
| | When Radio Resource Fluctuation is set to 0, it implies that |
| | the DL and UL data traffic is constant in data throughput. |
| | Hence, there is no fluctuation in Available Radio Resource. |
| | When Radio Resource Fluctuation is set to maximum value |
| | 255, the data traffic is very volatile in nature, which makes |
| | the Available Radio Resource unpredictable. |
| | The Radio Resource Fluctuation for all traffic models should |
| | be in the range of 0 to 255. |

Meanwhile, in the case in which the Indication Type parameter is set to ‘PHY Report’, parameters shown in the following Table 13 become valid.

TABLE 13

| Parameter | Remarks |
|---|---|
| MS MAC | 48-bit unique identifier of the MS |
| Address | |
| Downlink | Channel rate available for the MS calculated as a |
| Physical Service | multiple of 1/32 of nominal bandwidth in the |
| Level | correspondent direction assuming 1 bit/Hz. |
| | For example, if DL channel bandwidth is 10 MHz, |
| | value PSL = 4 means 4 × 1/32 × 10 Mbps = 1.25 |
| | Mbps. |
| | 1 PSL 96 (Number of subchannels in different |
| | OFDMA modes is multiple of 16 or 32; highest |
| | modulation QAM64 provides 3 bits/Hz) |
| Downlink RSSI | |
| mean | |
| Downlink RSSI | |
| standard | |
| deviation | |
| Downlink CINR | |
| mean | |
| Downlink CINR | |
| standard | |
| deviation | |
| Uplink Physical | Channel rate available for the MS calculated as a |
| Service Level | multiple of 1/32 of nominal bandwidth in the |
| | correspondent direction assuming 1 bit/Hz. (see |
| | definition of Downlink Physical Service Level) |
| Uplink RSSI | |
| mean | |
| Uplink RSSI | |
| standard | |
| deviation | |
| Uplink CINR | |
| mean | |
| Uplink CINR | |
| standard | |
| deviation | |

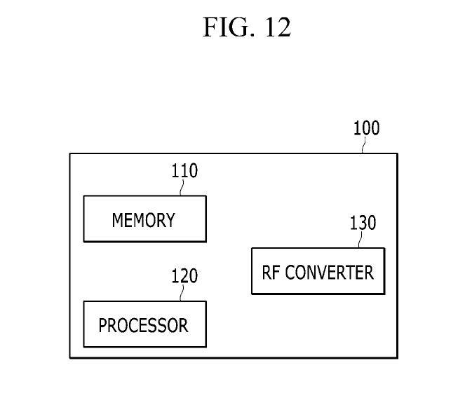

FIG. 12 is a diagram showing a configuration of a terminal 100 according to an exemplary embodiment of the present invention.

The terminal 100 may include a memory 110, a processor 120, and a radio frequency (RF) converter 130.

The processor 120 may be configured so as to implement procedures, methods, and functions related to the terminal 100 described with reference to FIGS. 1 to 11.

The memory 110 may be connected to the processor 120, and may store various information related to an operation of the processor 120 therein.

The RF converter 130 may be connected to the processor 120, and may transmit and receive a wireless signal. Meanwhile, the terminal 100 may have a single antenna or multiple antennas.

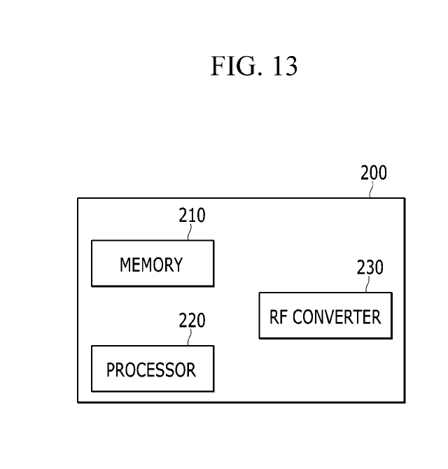

FIG. 13 is a diagram showing a configuration of a base station 200 according to an exemplary embodiment of the present invention.

The base station 200 may include a memory 210, a processor 220, and an RF converter 230. The base stations 201 and 202 may be configured so as to be similar to or the same as the base station 200.

The processor 220 may be configured so as to implement procedures, methods, and functions related to the base stations 200 to 202 described with reference to FIGS. 1 to 11.

The memory 210 may be connected to the processor 220, and may store various information related to an operation of the processor 220 therein.

The RF converter 230 may be connected to the processor 220, and may transmit and receive a wireless signal. Meanwhile, the base station 200 may have a single antenna or multiple antennas.

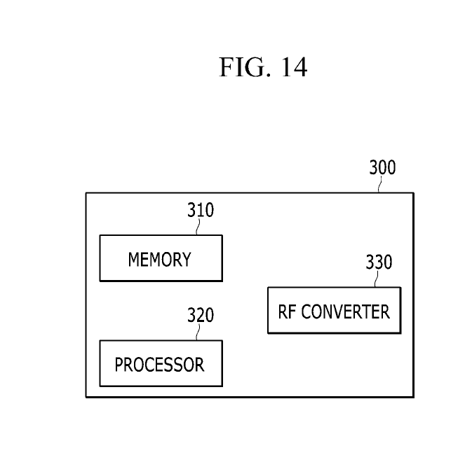

FIG. 14 is a diagram showing a configuration of a coordinator 300 according to an exemplary embodiment of the present invention.

The coordinator 300 may include a memory 310, a processor 320, and an RF converter 330.

The processor 320 may be configured so as to implement procedures, methods, and functions related to the coordinator 300 described with reference to FIGS. 1 to 11.

The memory 310 may be connected to the processor 320, and may store various information related to an operation of the processor 320 therein.

The RF converter 330 may be connected to the processor 320, and may transmit and receive a wireless signal. Meanwhile, the coordinator 300 may have a single antenna or multiple antennas.

An exemplary embodiment of the present invention relates to a method and an apparatus for managing and controlling a resource for controlling interference between cells in a mobile wireless access system.

According to an exemplary embodiment of the present invention, the interference between the cells in the mobile wireless access system may be controlled.

In addition, according to an exemplary embodiment of the present invention, a limited resource for controlling the interference may be efficiently used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A resource management method performed by a coordinator for controlling interference between cells, comprising:
receiving a channel state of a second base station neighboring a first base station from the first base station;
partitioning a resource based on the channel state;
allocating the partitioned resource to the first base station; and
transmitting a first message requesting resource management to be set to the first base station,
wherein the first message includes information on the allocated resource.

2. The resource management method of claim 1, wherein
the channel state includes information on channel quality of the second base station measured by a terminal, and
the partitioning of the resource
includes partitioning a frequency band into one or more frequency partitions using a frequency division multiplex (FDM) method.

3. The resource management method of claim 2, wherein
the partitioning of the frequency band into the one or more frequency partitions
includes partitioning a second region in which data are transmitted in a first region in which control information is transmitted and the second region within the frequency band into the one or more frequency partitions.

4. The resource management method of claim 2, wherein
the allocating
includes allocating a first frequency partition among the frequency partitions to the first base station, and
the transmitting of the first message
includes allowing bitmap information of a frequency subchannel of the first frequency partition to be included in the first message.

5. The resource management method of claim 2, wherein
the first message
further includes information regarding maximum transmission power strength allowable in each of the frequency partitions.

6. The resource management method of claim 1, wherein
the partitioning of the resource based on the channel state
includes partitioning the resource in a time axis using a time division multiplex (TDM) method to generate one or more partitions.

7. The resource management method of claim 6, wherein
the partitioning of the resource based on the channel state
further includes partitioning a first partition using either one of the TDM method and an FDM method when the first and second base stations share the first partition among the partitions with each other.

8. The resource management method of claim 6, wherein
the partitioning of the resource in a time axis using the TDM method
includes partitioning a region other than a first region in which control information is transmitted within a resource region in the time axis to generate the one or more partitions, when the first region includes a start point in time of a frame.

9. The resource management method of claim 6, wherein
the allocating
includes allocating a first partition among the partitions to the first base station, and
the first message
includes information on at least one of a start point in time and an end point in time of the first partition.

10. A resource management method performed by a first base station for controlling interference between cells, comprising:
receiving a channel state of a second base station neighboring the first base station from a terminal;
transmitting at least either one of the channel state and a use state of the resource to a coordinator;
receiving a first message requesting resource management to be set from the coordinator; and
using the resource based on information included in the first message.

11. The resource management method of claim 10, wherein
the channel state includes information on channel quality of the second base station measured by the terminal and information on interference of the second base station in the terminal, and
the use state of the resource
includes at least one of an average resource use rate per frame and a fluctuation degree of data traffic throughput.

12. The resource management method of claim 11, wherein
the transmitting of the at least either one of the channel state and the use state of the resource to the coordinator
includes transmitting the channel state and the use state of the resource to the coordinator when a channel state report request is received from the coordinator, when a period for the channel state report expires, when a value of either one of the channel state and the use state of the resource is increased or decreased by a first value, or when the value of either one of the channel state and the use state of the resource is higher than a first threshold value or is lower than a second threshold value.

13. The resource management method of claim 12, wherein
the using of the resource includes:
determining a first resource partition allocated to the first base station in the resource partitioned into one or more resource partitions based on the information included in the first message; and
allocating a portion of the first resource partition to the terminal.

14. The resource management method of claim 13, wherein
the using of the resource
further includes transmitting change information of the first resource partition to the terminal through a zone switch information element when the first resource partition is changed.

15. The resource management method of claim 13, wherein
the allocating of the portion of the first resource partition to the terminal includes:
determining a first point in time at which the first resource partition is available based on information on an application point in time in the information included in the first message; and
allocating the portion of the first resource partition to the terminal at the first point in time.

16. The resource management method of claim 10, wherein
the coordinator is present in the first base station.

17. A communication method of a terminal for decreasing interference between cells, comprising:
measuring channel quality of a first base station neighboring a serving base station;
reporting the measuring result to the serving base station when the measuring result satisfies a first condition;
receiving resource information from the serving base station; and
performing communication using the resource information.

18. The communication method of claim 17, wherein:
the first condition
includes at least any one of a case in which a channel state report request is received from the serving base station, a case in which a period for a channel state report expires, a case in which a value of the measuring result is increased or decreased by a first value, and a case in which the value of the measuring result is higher than a first threshold value or is lower than a second threshold value; and
the second threshold value is smaller than the first threshold value.

19. The communication method of claim 18, further comprising,
before the reporting,
receiving the first condition from the serving base station.

20. The communication method of claim 18, wherein
the resource information
corresponds to a first resource partition allocated to the serving base station in a resource partitioned into one or more resource partitions by a coordinator.
